(19) United States
(12) Patent Application Publication
(10) Pub. No.: US 2007/0120346 A1
(43) Pub. Date: May 31, 2007

(54) Air bag module

(75) Inventor: Hae Wook Kwon, Yongin-si (KR)

Correspondence Address: GREENBLUM & BERNSTEIN, P.L.C., 1950 ROLAND CLARKE PLACE, RESTON, VA, 20191, US

(73) Assignee: Hyundai Mobis Co., Ltd., Yongin-shi (KR)

(21) Appl. No.: 11/436,724

(22) Filed: May 19, 2006

(30) Foreign Application Priority Data
Nov. 23, 2005 (KR) 10-2005-0112096

(51) Int. Cl. B60R 21/217; B60R 21/205

(52) U.S. Cl. 280/728.2; 280/732; 280/728.3; 280/743.2

(57) ABSTRACT

An air bag module includes a first flap covering one side of a cushion, and a second flap covering the other side of the cushion, the second flap having a cut-out portion that is configured to be torn gradually by an expansion pressure of the cushion and to be coupled to the first flap.

### BACKGROUND OF THE INVENTION

1. Field of the Invention

The present invention relates to an air bag module, and more particularly, to an air bag module which suppresses the initial deployment of a cushion by a force of gradually tearing tear lines of flaps by an expansion pressure of the cushion when an expanding gas is supplied to the cushion.

2. Description of the Background Art

Generally, an air bag module is a device which is installed on a vehicle for protecting a passenger in the vehicle when a collision occurs. Such an air bag module installed on a vehicle is classified into a number of types, including a driver air bag (DAB) mounted on a handle for protecting a driver in a driver's seat, a passenger air bag (PAB) installed on an instrument panel in front of a passenger's seat for protecting the passenger in the passenger's seat, a side air bag (SAB) installed in a seat, etc. according to the installation position.

FIG. 1 is a cross sectional view of a passenger air bag module among air bag modules of several types. The air bag module according to the conventional art as illustrated in FIG. 1 comprises: an air bag housing 2 fixed to a vehicle; an inflator 4 installed within the air bag housing 2 for generating a high pressure expanding gas when a collision occurs; a cushion 6 into which the expanding gas generated from the inflator 4 is injected; and a cushion retainer 10 for securing the cushion 6 to the air bag housing 2.

In order to improve out-of-position (OOP) capability, one of the main capabilities of the air bag module, the air bag module further comprises first and second flaps 8 and 9 capable of preventing a sudden impact, such as a punch-out force, by which an occupant is injured as part of the cushion 6 where the expanding gas of the inflator 4 is concentrated is aggressively expanded toward the occupant during the initial deployment of the cushion.

That is, the first and second flaps 8 and 9 are installed so that they enclose the cushion 6 and cause friction against each other, in order to uniformly fill the expanding gas in the cushion 6 by suppressing the initial deployment of the cushion 6 by a friction force between the first and second flaps 8 and 9.

Typically, the first and second flaps 8 and 9 are coated so as to have a sufficient friction force, and have such a structure in which they overlap each other in layers.

The operation of the thus-constructed air bag module according to the conventional art will be described below.

When the cushion 6 receives an expanding gas from the inflator 4, the cushion 6 inflates as the expanding gas fills the cushion 6.

At this time, since the cushion 6 is enclosed by the first and second flaps 8 and 9 at the time of initial deployment of the cushion 6, the expanding gas is uniformly filled in the cushion 6 while suppressing the initial deployment of the cushion by a friction force between the first and second flaps 8 and 9. At this point, as the expanding gas fills the cushion 6, the first and second flaps 8 and 9 are gradually released by a friction against each other.

After the expanding gas is filled in the cushion 6 to a certain extent, and the first and second flaps 8 and 9 are completely released, the cushion 6 is expanded toward an occupant to its full shape, thereby protecting the occupant.

However, in the above air bag module according to the conventional art, because the initial deployment of the cushion 6 is suppressed by using a friction force caused by a frictional contact between the first and second flaps 8 and 9, the friction force between the first and second flaps 8 and 9 varies depending on the folding method, condition and degree of coating of the first and second flaps 8 and 9. This makes it difficult to tune a friction force of the first and second flaps 8 and 9 and test the performance therefore, and it is difficult to prevent a punch-out force phenomenon entirely.

### SUMMARY OF THE INVENTION

The present invention is directed to solve the prior art problems, and has for its object to provide an air bag module which is improved in OOP capability by suppressing the initial deployment of a cushion by a force of gradually tearing tear lines of flaps by an expansion pressure of the cushion when an expanding gas is supplied to the cushion.

To accomplish the above object, there is provided an air bag module according to the present invention, comprising: a first flap covering one side of a cushion; and a second flap covering the other side of the cushion and having a cut-out portion that can be torn gradually by an expansion pressure of the cushion and is coupled to the first flap.

To accomplish the above object, there is provided an air bag module according to the present invention, comprising: an air bag housing installed on an instrument panel opposite to a passenger's seat; an inflator installed on the air bag housing for supplying an expansion pressure; a cushion accommodated in the air bag housing and capable of deploying toward the passenger's seat upon receiving the expansion pressure; a cushion retainer for coupling the cushion to the air bag housing; a first flap whose one end couples to the air bag housing to cover one side of the cushion; and a second flap whose one end couples to the air bag housing to cover the other side of the cushion, wherein the second flap has a cut-out portion coupled to the first flap and formed by being segmented by a cutting line and two tear lines that can be torn gradually by the expansion pressure of the cushion, the two tear lines being connected to the cutting line.

### BRIEF DESCRIPTION OF THE DRAWINGS

In the drawings:

FIG. 1 is a cross sectional view of an air bag module according to the conventional art.

FIG. 2 is a cross sectional view of an air bag module according to the present invention;

FIG. 3 is a view showing an initial deployment state of the air bag module according to the present invention;

FIG. 4 is a view showing the condition after completion of deployment of the air bag module according to the present invention;

FIG. 5 is a plan view showing an exploded condition of a flap unit of the air bag module according to the present invention;

FIG. 6 is a deployment view showing an assembled condition of the flap unit of the air bag module according to the present invention;

FIG. 7 is a deployment view of the condition during initial deployment of the flap unit of the air bag module; and

FIG. 8 is a deployment view showing the condition after completion of deployment of the air bag module according to the present invention.

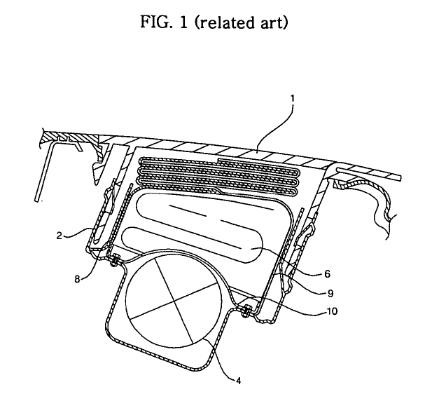

### DETAILED DESCRIPTION OF THE PREFERRED EMBODIMENTS

Hereinafter, preferred embodiments of the present invention will now be described in detail with reference to the accompanying drawings.

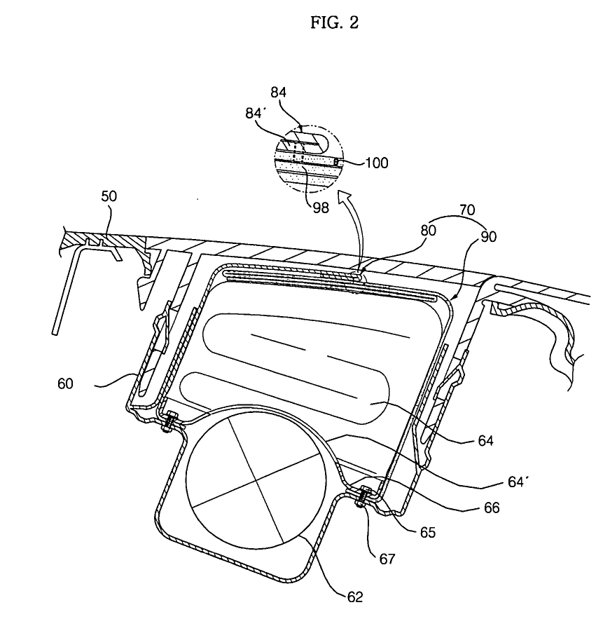

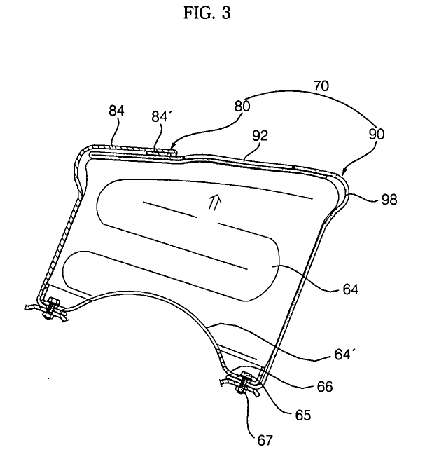

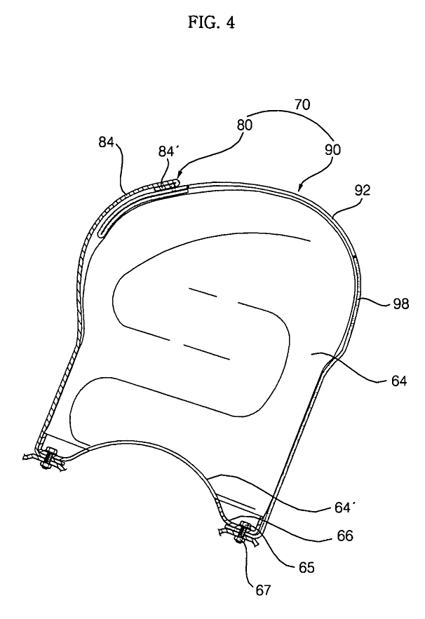

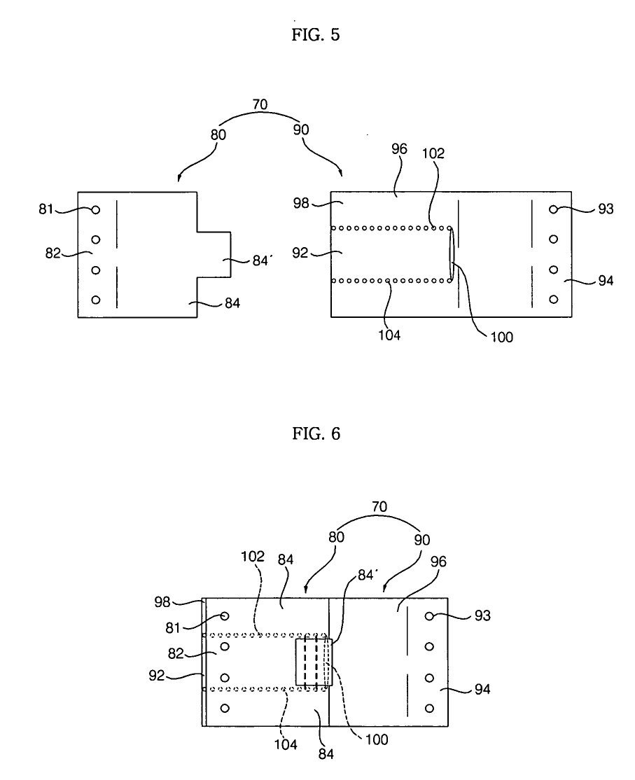

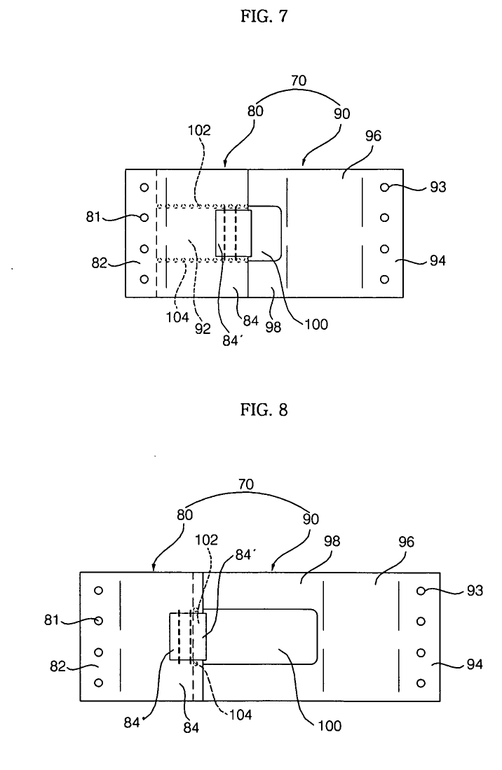

FIG. 2 is a cross sectional view of an air bag module according to the present invention. FIG. 3 is a view showing an initial deployment state of the air bag module according to the present invention. FIG. 4 is a view showing the condition after completion of deployment of the air bag module according to the present invention. FIG. 5 is a plan view showing an exploded condition of a flap unit of the air bag module according to the present invention. FIG. 6 is a deployment view showing an assembled condition of the flap unit of the air bag module according to the present invention. FIG. 7 is a deployment view of the condition during initial deployment of the flap unit of the air bag module. FIG. 8 is a deployment view showing the condition after completion of deployment of the air bag module according to the present invention.

The air bag module according to the present invention is a passenger air bag among air bag modules of various types, which comprises: an air bag housing 60 installed on an instrument panel 50 opposite to a passenger's seat; an inflator 62 installed on an inner rear part of the air bag housing 60 for supplying an expanding gas; a cushion 64 accommodated at an inner front part of the air bag housing, folded a plural number of times, and provided with an inlet portion 64′ at the inflator 62 for intaking the expanding gas from the inflator 62; a cushion retainer 66 for securing the inlet portion 64′ of the cushion 64 to the air bag housing 60; and a flap unit 70 for improving OOP capability.

The cushion retainer 66 is provided with studs 65 which are disposed within the cushion 64 and penetrate through the air bag housing 60 to be screwed onto stud nuts 67 on the outer side of the air bag housing 60, so that the inlet portion 64′ of the cushion 64 can be secured to the air bag housing 60.

The flap unit 70 includes a first flap 80 for covering one side of the cushion 64 and a second flap 90 disposed in the opposite side of the first flap 80 from the cushion 64 for covering the other side of the cushion 64, configured so as to be torn gradually by an expansion pressure of the cushion 64 and having a cut-out portion 92 coupled to the first flap 80.

The first flap 80 consists of a securing portion 82 secured to the air bag housing 60 and a cover portion 84 extending from the securing portion 82 of the first flap 80 to cover one side of the cushion 64 and part of the cut-out portion 92 of the second flap 90.

The securing portion 82 of the first flap 80 has stud holes 81, which are disposed between the inlet portion 64′ of the cushion 64 and the air bag housing 60 for allowing the studs 65 to penetrate through, so that it can be secured to the air bag housing 60 through the cushion retainer 66.

Of the cover portion 84 of the first flap 80, a region 84′ covering part of the cut-out portion 92 of the second flap 90 is formed such that its width W1 is smaller than the width W2 of the other regions, and sewn to the cut-out portion 92 of the second flap 90 so that the first flap 80 and the second flap 90 can be sewn and coupled to each other.

Of the cover portion 84 of the first flap 80, a region 84′ covering part of the cut-out portion 92 of the second flap 90 overlaps the outer side of the cut-out portion 92 of the second flap 90.

The second flap 90 consists of a securing portion 94 secured to the air bag housing 60, a cover portion 96 extending from the securing portion 94 of the second flap 90 for covering the other side of the cushion 64 and a folding portion 98 extending from the cover portion 96 to be folded at least once and having the cut-out portion 92.

The securing portion 94 of the first flap 90 has stud holes 91, which are disposed between the inlet portion 64′ of the cushion 64 and the air bag housing 60 for allowing the studs 65 to penetrate through, so that it can be secured to the air bag housing 60 through the cushion retainer 66.

The folding portion 98 of the second flap 90 is folded inward toward the second flap 90 and disposed between the front surface of the cushion 64 accommodated in the air bag housing 60 and the first flap 80.

The cut-out portion 92 of the second flap 90 is segmented from the other regions of the second flap by a cutting line 100 formed in a widthwise direction of the second flap 90 and two tear lines 102 and 104 connected to the cutting line, respectively, and formed at a predetermined length in a lengthwise direction of the second flap 90.

The two tear lines 102 and 104 of the second flap 90 may extend from the cutting line 100 of the second flap 90 up to the free end 90′ of the second flap 90 which is the end opposite to the securing portion 94 of the second flap 90.

The two tear lines 102 and 104 of the second flap 90 may be formed perpendicular to the cutting line 100 of the second flap 90.

The cut-out portion 92 of the second flap 90 can be easily tuned according to the length, spacing, etc. of the cutting line 100 of the second flap 90 and the two tear lines 102 and 104 of the second flap 90.

The cut-out portion 92 of the second flap 90 is sewn and coupled to the first flap 80 at the side of the cutting line 100 of the second flap 90 in the lengthwise direction of the second flap 90 so that the two tear lines 102 and 104 of the second flap 90 can be torn from the cutting line 100 of the second flap 90 by an expansion pressure of the cushion 64.

The operation of the thus-constructed air bag module according to the present invention will now be described in detail.

In such a state as illustrated in FIGS. 2 to 6, when an expanding gas is supplied into the cushion 64 from the inflator 62, the cushion 64 starts to inflate as the expanding gas fills the cushion 6.

At this time, as illustrated in FIGS. 3 to 7, the cut-out portion 92 of the second flap 90 is gradually torn toward the free end 90′ of the second flap 90 by an expansion pressure of the cushion 64, starting from the cutting line 100 of the second flap 90 along the two tear lines 1012 and 104 of the second flap 90.

As the cut-out portion 92 of the second flap 90 is torn, the folding portion 98 of the second flap 90 is gradually released to deploy the cushion 64 gradually toward a passenger's seat. Then, as illustrated in FIGS. 4 to 8, once the folding portion 98 of the second flap 90 is completely released, the cushion is expanded to its full shape, thereby protecting the occupant.

At this point, the initial deployment of the cushion 64 is suppressed before the folding portion 98 of the second flap 90 is released as the cut-out portion 92 of the second flap 90 is torn, and part of the expansion pressure of the cushion 64 is absorbed as the cut-out portion 92 of the second flap 90 is torn, thereby enabling the cushion 64 to be expanded to its full shape, with the expansion gas uniformly filled in the cushion 64.

Although these embodiments have been described with respect to the passenger air bag module, the flap unit of the present invention is also applicable to a drive air bag or a side air bag.

The thus-constructed air bag module according to the present invention suppress the deployment of the cushion as the cut-out portion of the second flap is torn during deployment of the cushion by having at the second flap the cut-out portion coupled to the first flap and gradually tearable by an expansion pressure of the cushion, the first and second flaps being coupled to each other. Thus, the air bag module can improve OOP capability since it has a higher binding force than the conventional flaps using a friction force.

Furthermore, in the present invention, the cutting line and the tear lines are formed on the second flap so as to tear the cut-out portion of the second flap and the force of suppressing the deployment of the cushion can be easily tuned by the first and second flaps by adjusting the length, spacing, etc. of the cutting line and tear lines of the second flap. Thus, this makes it easy to control dimensions and judge compatibility through a naked eye test.

Furthermore, in the present invention, the first and second flaps do not need to be coated for acquiring a friction force, thus making it possible to reduce the cost, and the folding portion is provided only on the second flap, which can decrease the length of the first flap as compared to the conventional art, thus making it possible to reduce the cost.

Furthermore, in the present invention, the folding portion is provided only on the second flap, so only the second flap needs to be folded, thereby improving workability.

What is claimed is:

1. An air bag module, comprising:
a first flap covering one side of a cushion; and
a second flap covering the other side of the cushion, the second flap having a cut-out portion that is configured to be torn gradually by an expansion pressure of the cushion and to be coupled to the first flap.

2. The air bag module as claimed in claim 1, wherein the first and second flaps are sewn and coupled to each other.

3. The air bag module as claimed in claim 1, wherein the first flap comprises a securing portion secured to an air bag housing where the cushion is accommodated and a cover portion extending from the securing portion of the first flap to cover one side of the cushion and part of the cut-out portion of the second flap.

4. The air bag module as claimed in claim 1, wherein the first flap is coupled to an air bag housing along with a cushion retainer to couple the cushion to the air bag housing.

5. The air bag module as claimed in claim 1, wherein the first flap is configured such that a region coupled to the cut-out portion of the first flap has a smaller width than the other regions.

6. The air bag module as claimed in claim 1, wherein the second flap has a securing portion which couples to an air bag housing where the cushion is accommodated through the cushion retainer supporting the cushion.

7. The air bag module as claimed in claim 1, wherein the second flap has a folding portion being foldable at least once and having the cut-out portion.

8. The air bag module as claimed in claim 1, wherein the cut-out portion of the second flap is segmented from the other regions of the second flap by a cutting line formed in a widthwise direction of the second flap and two tear lines connected to the cutting line, respectively, and formed in a lengthwise direction of the second flap.

9. The air bag module as claimed in claim 8, wherein one end of the second flap is secured to an air bag housing, and each of the tear lines extends up to the unconstrained free end of the second flap.

10. An air bag module, comprising:
an air bag housing installed on an instrument panel opposite to a passenger's seat;
an inflator installed on the air bag housing to supply an expansion pressure;
a cushion accommodated in the air bag housing and capable of deploying toward the passenger's seat upon receiving the expansion pressure;
a cushion retainer that couples the cushion to the air bag housing;
a first flap, one end of the first flap coupling to the air bag housing to cover one side of the cushion; and
a second flap, one end of the second flap coupling to the air bag housing to cover the other side of the cushion,
wherein the second flap has a cut-out portion coupled to the first flap and formed by being segmented by a cutting line and two tear lines that can be torn gradually by the expansion pressure of the cushion, the two tear lines being connected to the cutting line.
